(19) United States
(12) Patent Application Publication
(10) Pub. No.: US 2025/0344307 A1
(43) Pub. Date: Nov. 6, 2025

(54) CHARGING DEVICE

(71) Applicant: Nippon Telegraph and Telephone Corporation, Tokyo (JP)

(72) Inventors: Atsushi NAGAO, Musashino-shi, Tokyo (JP); Takashi IKEDA, Musashino-shi, Tokyo (JP); Masato MARUYAMA, Musashino-shi, Tokyo (JP); Toshihisa MASUDA, Musashino-shi, Tokyo (JP)

(21) Appl. No.: 18/869,066

(22) PCT Filed: Jun. 8, 2022
(86) PCT No.: PCT/JP2022/023159

§ 371 Date: Nov. 25, 2024

(51) Int. Cl. H05F 3/02; B64D 45/02; B64U 20/80; H02J 50/00

(52) U.S. Cl. CPC H05F 3/02; B64D 45/02; B64U 20/80; H02J 50/001

(57) ABSTRACT

A charging device 30 includes a lightning rod 31 and a charging circuit 32 connected between the lightning rod 31 and a ground. A wire 11 is dropped from a drone 10 in the air toward the lightning rod 31 of the charging device 30, and the lower end of the wire 11 and the lightning rod 31 are brought close to each other. A discharge phenomenon is caused to occur between the lower end of the wire 11 and the lightning rod 31 to induce lightning, and a lightning surge is caused to flow to the charging circuit 32 via the wire 11 and the lightning rod 31.

### TECHNICAL FIELD

The present invention relates to a charging device.

### BACKGROUND ART

In order to eliminate damage caused by a lightning strike, a technology has been devised of flying a drone under a thundercloud to capture a lightning strike and guiding the lightning strike to the ground. In Non Patent Literature 1, a technology has been proposed for inducing lightning by dropping a metal wire from the air. In Non Patent Literature 2, a technology has been studied of connecting a drone and a charging device by a conductive wire and charging lightning strike energy.

### CITATION LIST

### Non Patent Literature

Non Patent Literature 1: D. Wang, F. Wang, W. Lu, Y. Zhang, Q. Meng, and G. Zhang, “Triggering Lightning Discharges at Various Controllable Altitudes and Their Potential Applications”, International Conference on Atmospheric Electricity, Aug. 8-12, 2011, Brazil Non Patent Literature 2: “Lightning control and charging technology”, [online], Dec. 3, 2021, NIPPON TELEGRAPH AND TELEPHONE CORPORATION, Internet <URL: https://www.rd.ntt/research/SE0010.html>

### SUMMARY OF INVENTION

### Technical Problem

In order to perform charging with lightning strike energy, it is necessary to receive lightning, and charge a capacitor or a battery. In order to efficiently perform charging with the lightning strike energy, it is only necessary to induce lightning under a thundercloud.

Use of a grounded conductive high structure is likely to induce a lightning strike on the high structure. At the tip of the high structure, since an interval between equipotential surfaces becomes narrow, that is, an electric field strength becomes high, upward streamer to a stepped leader coming down from a thundercloud, or a stepped leader toward a thundercloud is likely to occur. On the other hand, corona discharge is likely to occur at the tip of the high structure. When a thundercloud strikes, corona charges generated by corona discharge are diffused in the air to form a corona charged layer. The corona charged layer functions as an electrostatic shield for the high structure and functions to weaken the electric field strength at the tip of the high structure. That is, the corona charged layer may alleviate electric field concentration at the tip of the high structure and prevent a lightning strike on the high structure.

In addition, in the method of Non Patent Literature 2, since the drone and the charging device are connected to each other by the conductive wire, the method of dropping the wire of Non Patent Literature 1 cannot be performed, and it is difficult to induce lightning.

The present invention has been made in view of the above, and an object of the present invention is to efficiently perform charging with lightning strike energy.

### Solution to Problem

A charging device of an aspect of the present invention is a charging device that performs charging with lightning via a wire attached to a flying object, the charging device including: a lightning rod; and a charging circuit connected between the lightning rod and a ground, in which a lower end of the wire dropped from the flying object and the lightning rod are brought close to each other to induce a lightning strike on the flying object or the wire, and a lightning surge is caused to flow to the charging circuit via the wire and the lightning rod.

### Advantageous Effects of Invention

According to the present invention, it is possible to efficiently perform charging with lightning strike energy.

### BRIEF DESCRIPTION OF DRAWINGS

FIG. 1 is a diagram illustrating an example of a configuration of a charging system of Example 1.

FIG. 2 is a diagram illustrating an example of an equipotential surface when a wire is dropped.

FIG. 3 is a diagram illustrating an example of the equipotential surface when discharge occurs between the wire and a lightning rod.

FIG. 4 is a diagram illustrating an example of a configuration of a charging system of Example 2.

### DESCRIPTION OF EMBODIMENTS

Hereinafter, an embodiment of the present invention will be described using the drawings.

### Example 1

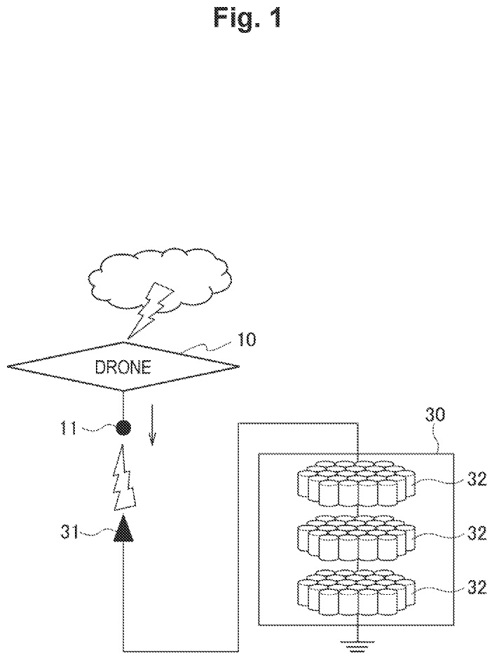

FIG. 1 is a diagram illustrating an example of a configuration of a charging system of Example 1. The charging system illustrated in the figure includes a drone 10 and a charging device 30.

The drone 10 holds a wire 11 made of metal. The drone 10 drops the wire 11 by remote control. One end of the wire 11 is connected to the drone 10, and the other end of the wire 11 is dropped.

In order to prevent the drone 10 from having difficulty in flying due to a direct lightning strike on the drone 10, it is good to surround the drone 10 by a Faraday cage, and connect one end of the wire 11 to the Faraday cage. For example, a faraday cage is formed by surrounding the periphery of the drone 10 with a grid-like conductor. When the drone 10 with the faraday cage is struck by lightning, electric fields generated by currents cancel each other inside the faraday cage, so that influence on the drone 10 can be extremely reduced. A lightning surge received by the faraday cage flows to the charging device 30 via the wire 11.

The charging device 30 includes a lightning rod 31 and a charging circuit 32.

The lightning rod 31 is a needle-shaped or rod-shaped conductor and is connected to the charging device 30 by a conductive wire. The lightning rod 31 may be attached to the tip of a columnar structure.

The charging circuit 32 is connected between the lightning rod 31 and a ground. In order to prevent destruction and increase an amount of charge, it is good to configure the charging circuit 32 by combining parallel connection and series connection of capacitors. For example, the charging circuit 32 is configured by connecting a plurality of capacitor groups each including a plurality of capacitors connected together in parallel is connected together in series.

The wire 11 dropped from the drone 10 approaches the tip of the lightning rod 31, whereby a discharge phenomenon occurs between the lower end of the wire 11 and the lightning rod 31, lightning strike energy flows to the charging device 30, and charging is performed.

Here, a lightning induction technology using a drone will be described.

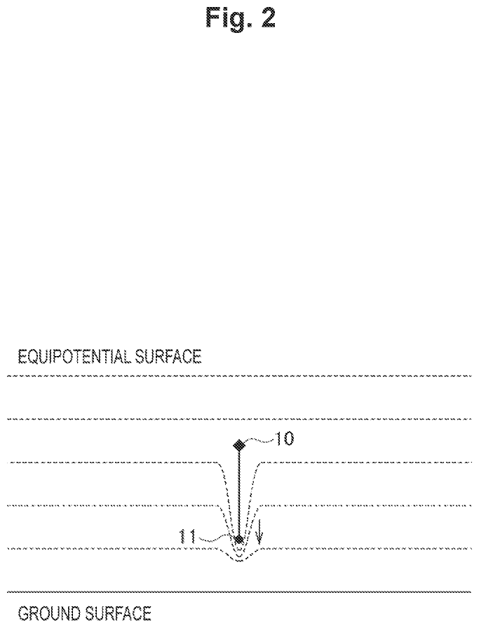

As illustrated in FIG. 2, when the wire 11 is dropped from the drone 10 stationary in the air, an equipotential surface around the wire 11 protrudes downward, and an electric field strength at the lower end of the wire 11 increases.

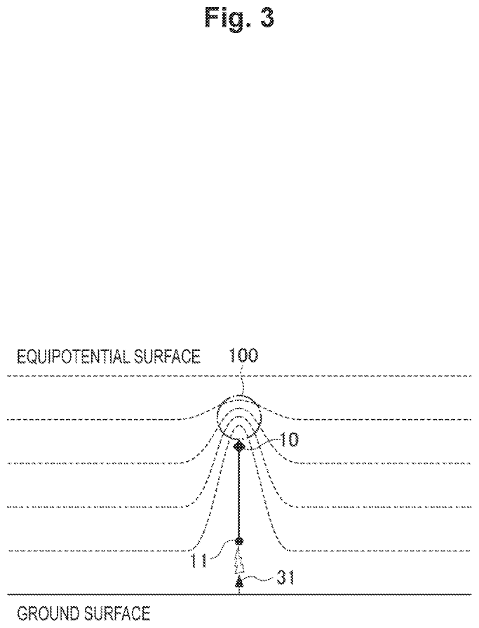

When the lower end of the wire 11 approaches a ground surface (lightning rod 31) and the lower end of the wire 11 and the lightning rod 31 are close to each other, it is assumed that discharge occurs. By the discharge, the wire 11 is instantaneously brought into a grounded state, and as illustrated in FIG. 3, the equipotential surface around the wire 11 changes to protrude upward. As a result, before corona charges are diffused, ideal electric field concentration is implemented in a region 100 at the upper end of the wire 11, and a lightning strike on the drone 10 or the wire 11 can be induced.

When charging is performed with the lightning strike energy, the drone 10 and the charging device 30 are mounted on a vehicle, the vehicle moves to an area where lightning is likely to occur, the lightning rod 31 connected to the charging device 30 is arranged, and the drone 10 is flown into the sky. The drone 10 flies at an altitude that is a sum of a length of the wire 11 and a height of the lightning rod 31 under a thundercloud. The wire 11 is dropped from the drone 10 toward the lightning rod 31.

When the tip of the wire 11 and the lightning rod 31 are close to each other and discharge occurs, a lightning strike on the drone 10 or the wire 11 is induced, a lightning surge received by the drone 10 or the wire 11 flows to the charging device 30 via the wire 11, and charging is performed. The wire 11 and the lightning rod 31 may be brought into contact with each other.

Note that the lightning strike energy with which charging is performed by the charging device 30 may be used as driving energy for the vehicle.

### Example 2

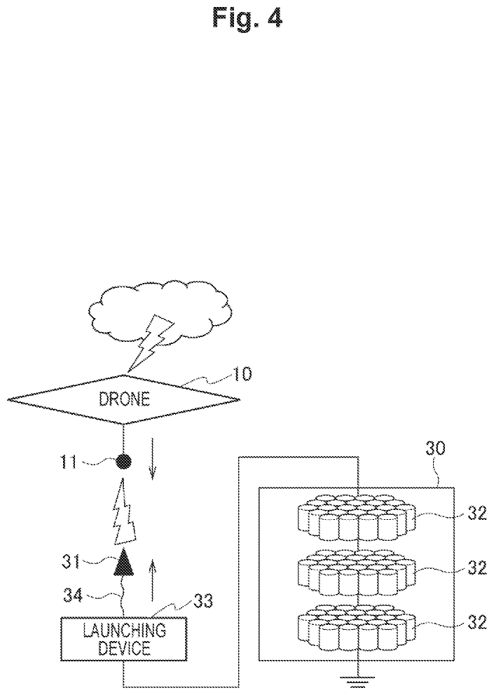

FIG. 4 is a diagram illustrating an example of a configuration of a charging system of Example 2. The charging system illustrated in the figure includes the drone 10 and the charging device 30.

As in Example 1, the drone 10 holds the wire 11 and drops the wire 11 by remote control. One end of the wire 11 is connected to the drone 10. The drone 10 may be the drone 10 with the faraday cage.

The charging device 30 includes the lightning rod 31, the charging circuit 32, a launching device 33, and a wire 34.

The lightning rod 31 is a needle-shaped conductor and is connected to the launching device 33 by the wire 34 made of metal. The lightning rod 31 is connected to one end of the wire 34, and the other end of the wire 34 is connected to the charging device 30 by a conductive wire. That is, the lightning rod 31 is electrically connected to the charging device 30.

The charging circuit 32 is connected between the lightning rod 31 and the ground. Similarly to Example 1, for the charging circuit 32, it is good to combine parallel connection and series connection of capacitors.

The launching device 33 is a device that launches the lightning rod 31 into the sky. For example, the launching device 33 launches the lightning rod 31 by using gunpowder, air pressure, or elasticity of rubber or a spring. It is good to launch the lightning rod 31 up to a height at which surrounding people, buildings, or facilities are in a protection range according to a protective angle method. As a result, it is possible to suppress a lightning strike on an unintended place.

The wire 11 dropped from the drone 10 approaches the launched lightning rod 31, whereby a discharge phenomenon occurs between the wire 11 and the lightning rod 31, a lightning strike is induced, lightning strike energy flows to the charging device 30, and charging is performed.

When charging is performed with the lightning strike energy, the drone 10 and the charging device 30 are mounted on a vehicle, the vehicle moves to an area where lightning is likely to occur, the drone 10 is flown into the sky, and the launching device 33 is arranged below the drone 10. The launching device 33 launches the lightning rod 31 in accordance with a timing at which the wire 11 is dropped from the drone 10. When the tip of the wire 11 and the lightning rod 31 are close to each other and discharge occurs, a lightning strike on the drone 10 or the wire 11 is induced, a lightning surge received by the drone 10 or the wire 11 flows to the charging device 30 via the wires 11 and 34 and the lightning rod 31, and charging is performed. The lightning rod 31 may be launched at the same timing as dropping of the wire 11, or the lightning rod 31 may be launched toward the lower end of the wire 11 after the wire 11 is dropped.

As described above, the charging device 30 of the present embodiment is the charging device 30 for performing charging with lightning via the wire 11 attached to the drone 10. The charging device 30 includes the lightning rod 31 and the charging circuit 32 connected between the lightning rod 31 and the ground. The wire 11 is dropped from the drone 10 in the air toward the lightning rod 31 of the charging device 30, the lower end of the wire 11 and the lightning rod 31 are brought close to each other, and a discharge phenomenon is caused to occur between the lower end of the wire 11 and the lightning rod 31. When the discharge phenomenon occurs between the wire 11 and the lightning rod 31, the wire 11 is instantaneously brought into the grounded state, and before corona charges are diffused, ideal electric field concentration is implemented in the region 100 at the upper end of the wire 11. As a result, a lightning strike on the drone 10 or the wire 11 can be induced, and a lightning surge flows to the charging circuit 32 via the wire 11 and the lightning rod 31.

### REFERENCE SIGNS LIST

10 Drone
11 Wire
30 Charging device
31 Lightning rod
32 Charging circuit
33 Launching device
34 Wire

1. A charging device that performs charging with lightning via a wire attached to a flying object,
the charging device comprising:
a lightning rod; and
a charging circuit connected between the lightning rod and a ground, wherein
a lower end of the wire dropped from the flying object and the lightning rod are brought close to each other to induce a lightning strike on the flying object or the wire, and a lightning surge is caused to flow to the charging circuit via the wire and the lightning rod.

2. The charging device according to claim 1, comprising
a launching unit that launches the lightning rod into a sky,
wherein
the lightning rod is launched in accordance with a timing at which the wire is dropped.

3. The charging device according to claim 1,
wherein
in the charging circuit, a plurality of capacitor groups each including a plurality of capacitors connected together in parallel is connected together in series.
